(19) United States
(12) Patent Application Publication
(10) Pub. No.: US 2024/0228374 A1
(43) Pub. Date: Jul. 11, 2024

(54) METHOD OF PRODUCING CLAY ACTIVATED/CALCINED WITH CALCIUM ALUMINOFERRITE OR CALCIUM FERRITE AND CLAY COMPOSITION OBTAINED BY THE METHOD

(71) Applicant: FCT HOLDINGS PTY LTD., Thebarton, South Australia (AU)

(72) Inventors: Pedro LUCAS GERVASIO LADEIRA, BELO HORIZONTE (BR); Adriano BARROS GRECO, Fort Lauderdale, FL (US)

(73) Assignee: FCT HOLDINGS PTY LTD., Thebarton, South Australia (AU)

(21) Appl. No.: 18/029,794

(22) PCT Filed: Oct. 27, 2020
(86) PCT No.: PCT/BR2020/050439

§ 371 Date: Mar. 31, 2023

(51) Int. Cl. C04B 14/10; C04B 14/36; C04B 20/04

(52) U.S. Cl. CPC C04B 14/10; C04B 14/363; C04B 20/04

(57) ABSTRACT

The present invention patent refers to a method of obtaining a clay composition activated/calcined with a fraction of calcium aluminoferrite or calcium ferrite and clay composition obtained by the aforementioned method, more precisely belonging to the field of industrial cement manufacturing, where said method discloses a process of forming calcium aluminoferrite or calcium ferrite in-situ to deliver an activated/calcined clay from red clay that is most appreciated for adding to a cement composition.

### TECHNICAL FIELD OF THE INVENTION

The present invention patent refers to a method of producing clay activated/calcined with calcium aluminoferrite or calcium ferrite and clay composition obtained by the aforementioned method, more precisely belonging to the field of production of cementitious materials where said method discloses a process of forming calcium aluminoferrite or calcium ferrite (in the form of Brownmillerite, for example) in-situ to obtain an activated/calcined clay from red clay that is acceptable to be aggregated to cement.

### BACKGROUND OF THE INVENTION

Clays with potential cementitious properties, often called artificial pozzolanic clays or with pozzolanic activity when activated/calcined in a rotary oven in normal operating condition, generate an activated/calcined clay of good quality. However, depending on its iron oxide content, its red color significantly affects the color of the cement when using this material as an additive.

Therefore, the process of manufacturing activated/calcined clay from red clays is known, but little used, on account of the color of activated/calcined clay produced.

In this conventional process, the clay is pure calcined, the calcination temperature of the material does not exceed 900° C., generating an activated/calcined clay of red color that, when added to the clinker, changes its color to reddish, causing the rejection of use by the consumer and even distrust of the quality of the product. It is emphasized that the quality of the product is not compromised, but there is a custom as to the color of the cement.

### STATE OF THE ART

In research carried out in specialized databases, documents were found referring to the method of clay production and clay composition, as presented in the document No. PI 1002450 that refers to the manufacturing process of activated artificial pozzolan, obtained from clays, or clay mixtures, with the addition of fuels in the granulometric range from 0 to 10 mm, in proportions ranging from 1% up to 10% of the mixture. These clays, or mixtures of clays, when calcined at temperatures between 600° C. and 900° C., in a reducing environment, generate the so-called activated artificial pozzolan, which is reactive when in contact with water, giving the material binder properties. Contrary to the present invention, the document does not disclose the in-situ formation of calcium aluminoferrite or calcium ferrite.

The document No. WO12142547 discloses a cementitious composition including: a binder containing (a) 60-94% by weight of at least one pozzolanic material; (b) at least 0.5% calcium sulfoaluminate (CSA) by weight; (c) 1.2-1 1% by weight, expressed as SO3, of at least one inorganic sulfate selected from the sulfate group consisting of a hemihydrate calcium sulfate, an anhydrous calcium sulfate, a dihydrated calcium sulfate, a sodium sulfate and a sodium and calcium sulfate; and (d) a total sulfate content of at least 3% by weight, expressed as SO3, the cementitious composition including a maximum of 3% natural lime, cementitious composition including a maximum of 10% alumina cement, the contents of the composition being calculated on a dry and non-aggregate basis.

The above document discloses the inclusion/addition of andradite in pozzolanic cement, however, does not disclose the formation of calcium aluminoferrite or calcium ferrite (in the form of Brownmillerite, for example) in-situ in calcination.

Therefore, there is a need for activated/calcined clay and methods that seek the production thereof using easily accessible materials that are underutilized, such as red clay, resulting in acceptance by the consumer market for the promotion of cement-compatible coloring.

### OBJECTIVES OF THE INVENTION

The present invention enables the use of red clays, especially those whose Fe2O3 content exceeds 4% by mass, until presently an abundant reserve and easy to access, underutilized for the manufacture of activated/calcined clay. Clay reserves are widely dispersed and available worldwide, including in the overburden of limestone deposits.

In this respect, the applicant found, surprisingly and unexpectedly, that the composition is capable of promoting such benefits, and, in particular, producing an activated/calcined clay of appropriate color for use in cements.

It is the objective of the invention, therefore, to present a method of obtaining activated/calcined clay composition with the production of calcium aluminoferrite or calcium ferrite in-situ using of red clay by modifying its color in calcination. This feat was achieved by combining raw material for clinker manufacturing for cement and red clay, calcined and clay oven activated/calcined at a temperature over 900° C.

Another objective of this invention is to present a method of obtaining activated/calcined clay composition with calcium aluminoferrite or calcium ferrite that allows the use of red clay by modifying its color in calcination from reddish to grayish.

Another objective of this invention is to present an activated/calcined clay composition comprising calcium aluminoferrite, preferably a calcium aluminoferrite or calcium ferrite resulting from in-situ formation during calcination.

This invention also presents an activated/calcined clay composition of grayish color derived from red clay as raw material that allows use in cements, free of substantial deviations of color.

### DESCRIPTION OF THE DRAWINGS

To complement this description in order to obtain a better understanding of the characteristics of this invention and according to a preferential practical embodiment hereof, the description is accompanied by a set of diagrams, where, in an exemplified way, although not limited, the following is represented:

FIGS. 1 and 2 represent diagrams where it can be seen that all products formed in the Ca—Fe—O method, in which the Ca₂Fe₂O₅ product can be identified as C₂F and the CaFe₂O₄ product can be identified as CF;

FIG. 3 shows a graph of the increase in the Ca/Fe ratio in the increase in reaction yield; and

FIG. 4 shows a graph of the X-ray diffraction patterns of calcium ferrites prepared from the mixture of CaO and Fe₂O₃ with Ca/Fe ratio between 0.33 and 3 in mass.

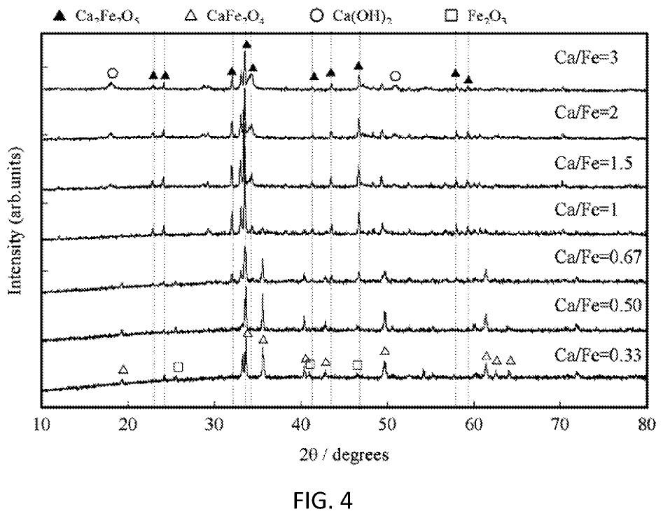

### DESCRIPTION OF THE INVENTION

With reference to the drawings, the present invention patent refers to the “METHOD OF PRODUCING CLAY ACTIVATED/CALCINED WITH CALCIUM ALUMINOFERRITE OR CALCIUM FERRITE AND CLAY COMPOSITION OBTAINED BY THE METHOD”, more precisely it is a method of obtaining the clay composition activated/calcined with calcium aluminoferrite or calcium ferrite and clay composition obtained.

According to the present invention, the method of obtaining activated/calcined clay composition includes the in-situ generation of calcium aluminoferrite or calcium ferrite for correcting the color of activated clay. This method presents itself as an alternative to traditional methods of color control.

The modification of the color of red clay carried out in the activation/calcination step by the method of generation in-situ of calcium aluminoferrite or calcium ferrite is achieved by the combination of raw material for cement manufacturing in the basic phase of clinker manufacture for cement, notified limestone and/or clinker flour, similar sources of calcium oxide, and red clay calcined in an activated/calcined clay oven at a temperature over 900° C.

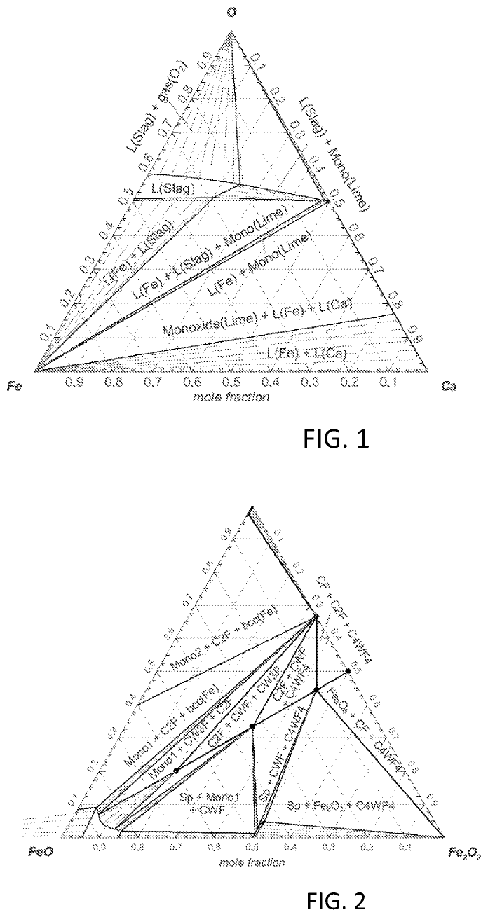

Said method of obtaining activated/calcined clay composition presents the following steps:
(a) The mixture of clay and limestone and/or clinker flour is fed in the oven in counterflow to exhaust gases, produced by burning fuel, dragged inside the oven through an extractor hood. The activated/calcined clay is obtained at a temperature over 900° C., with a mixing residence time inside the oven of approximately 45-90 minutes;
(b) Weighing the typical raw material mass for the manufacture of clinker for cement in the basic phase to be added in order to provide CaO necessary to maintain the stoichiometric ratio of the reaction (1), considering a typical raw material for the manufacture of clinker for cement of typical composition as an example for calculations, wherein:

| SiO₂ | Al₂O₃ | Fe₂O₃ | CaO | MgO | SO₃ | Na₂O | K₂O |
|---|---|---|---|---|---|---|---|
| (%) | (%) | (%) | (%) | (%) | (%) | (%) | (%) |
| 12.8 | 2.8 | 1.8 | 43.2 | 1.0 | 0.4 | 0.3 | 0.6 |

wherein 43.2% of the typical raw material mass for the manufacture of clinker for cement corresponds to the compound CaO (reagent of interest). Thus, the addition of 1 kilo of this typical raw material for the manufacture of clinket for cement to the system corresponds to the addition of 432 grams of CaO. According to the reaction (1) the stoichiometric ratio is 2:1, and two CaO mols are required to react with one mol of Fe₂O₃. The molar mass of CaO of approximately 56.1 g/mol and the molar mass of Fe₂O₃ of approximately 159.6 g/mol are considered. In a stoichiometric ratio with the estimated yield (75%) 112.2 grams of CaO and 159.6 grams of Fe₂O₃ are required to produce 203.8 grams of Ca₂Fe₂O₅. Taking into account the data of typical raw material for the manufacture of clinker for cement considered it is necessary to add 260 g of typical raw material for the manufacture of clinker for cement in the method for reducing 159.6 g of Fe₂O₃. With regard to the temperature of the reaction, production data of Ca₂Fe₂O₅ between 700° C. and 1300° C. were found, being the maximum yield of the reaction at a temperature of 1100° C. Due to the transformation characteristics of the activated/calcined clay, the use of temperatures between 900° C. and 1050° C. is indicated;
(c) In possession of the thermodynamic data of the reagents and products involved in the reactions (1) and (2) it is possible to calculate Gibbs-free energy for the formation of both products. The first reaction has Gibbs-free energy of formation equal to −59110.45 kJ/mol, while the second reaction presents Gibbs-free energy of formation equal to −36 433,495. Due to the large negative Gibbs-free energy values of both reactions, it is concluded that these are spontaneous and the formation of Ca₂Fe₂O₅ is more thermodynamically favorable (higher negative value);
(d) The reaction between CaO and Fe₂O₃ leads to the formation, mainly, of two products: Ca₂Fe₂O₅, known as Brownmillerite, and CaFe₂O₄ (see FIG. 1), both calcium ferrites. The formation reaction of the two compounds can be described by the reactions:

2CaO+Fe₂O₃->Ca₂FeO₅ (1)

CaO+Fe₂O₃->CaFeO₄ (2)

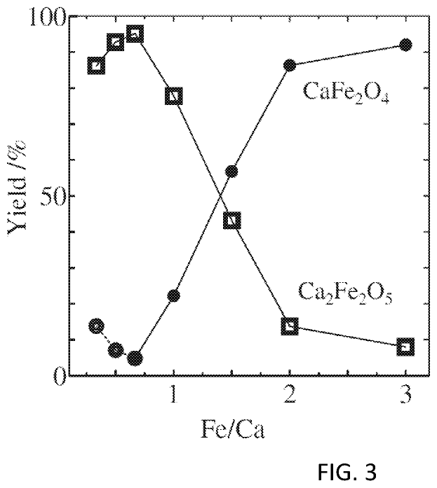

The main parameter that leads to the formation of one product in detriment of the other is the Ca/Fe ratio. Studies indicate an increase in the formation of Ca₂Fe₂O₅ for Ca/Fe>1, with 75% being the yield of a stoichiometric reaction (see FIG. 3). Though well-known according to Hirabayashi, et. al. (2006) that the increase of the Ca/Fe ratio to 3 culminates in the increase in the reaction yield, to ensure the economicity of the activated/calcined clay produced, we indicate only the addition of “typical raw material for the manufacture of clinker for cement” until the stoichiometric ratio of the reaction is maintained (1).

The composition of clay obtained is activated/calcined comprising calcium aluminoferrite or calcium ferrite, preferably a calcium aluminoferrite or calcium ferrite resulting from in-situ formation during calcination.

The activated/calcined clay of the present invention presents greenish gray or brown coloration, which allows the use thereof in cements, free of substantial deviations of color.

It is certain that when this invention is put into practice, changes may be made with regard to certain details, without this implying departing from the fundamental principles that are clearly substantiated in the set of claims, thus it is understood that the terminology used did not have the purpose of limiting.

1.-4. (canceled)

5. A method of producing clay activated/calcined with calcium aluminoferrite or calcium ferrite and clay composition comprising:
obtaining calcium aluminoferrite or calcium ferrite in-situ to change the color of the red clay during calcination in a clay oven activated/calcined at a temperature over 900° C. for approximately 45-90 minutes in counterflow to exhaust gases; said calcined red clay being acceptable to be added to cement.

6. The method according to claim 5, further comprising the following steps:
providing a first raw material, namely, a mixture of clay and limestone typical for the manufacture of clinker for cement, or other sources of calcium oxide or calcium carbonate; and
providing a second raw material, that is, the red clay produced in the activated/calcined clay oven;
wherein the reaction between the first typical raw material CaO and Fe₂O₃, during calcination, should be measured in order to maintain the supply of CaO necessary for the stoichiometric ratio of the reactions
2CaO+Fe₂O₃→Ca₂FeO₅ and (1)
CaO+Fe₂O₃→Ca₂FeO₄ (2)

7. A clay composition obtained by the method of claim 5, wherein the composition comprises activated/calcined clay from red clay including calcium aluminoferrite—Ca₄Al₂Fe₂O₁₀—or calcium ferrite—Ca₂FeO₅ or Ca₂FeO₄.

8. The clay composition obtained by the method of claim 5, wherein the resulting composition is greenish or brownish gray color acceptable for use in cements.
